(19) United States
(12) Patent Application Publication
(10) Pub. No.: US 2016/0274054 A1
(43) Pub. Date: Sep. 22, 2016

(54) Sensor For Detecting A Gas Content

(71) Applicant: CONTINENTAL AUTOMOTIVE GmbH, Hannover (DE)

(72) Inventors: Johannes ANTE, Regensburg (DE); Philippe GRASS, Regensburg (DE)

(21) Appl. No.: 14/778,435

(22) PCT Filed: Mar. 19, 2014
(86) PCT No.: PCT/EP2014/055521

§ 371 Date: Sep. 18, 2015

(30) Foreign Application Priority Data
Mar. 20, 2013 (DE) 10 2013 204 914.5

(51) Int. Cl. G01N 27/417; G01N 27/407; G01N 27/30; G01N 27/406

(52) U.S. Cl. CPC G01N 27/417; G01N 27/4067; G01N 27/4072; G01N 27/4074; G01N 27/307

(57) ABSTRACT

A sensor for detecting a gas content includes: a sensor body; an electrode chamber arranged in the sensor body; a first heating element embedded in the sensor body and configured to heat a specified region to a specified operating temperature; and an inlet duct, in the sensor body, coupled to the electrode chamber and having an inlet on the surface of the sensor body. The inlet duct is arranged such that, during operation of the sensor at the specified operating temperature, the inlet is axially spaced from the electrode chamber such that the sensor body is at a maximum temperature at the surface of the sensor body in a region around the inlet, which temperature is less than or equal to a temperature threshold that ensures that an air-fuel mixture flowing past the inlet will not be ignited.

### CROSS-REFERENCE TO RELATED APPLICATIONS

This is a U.S. national stage of application No. PCT/EP2014/055521, filed on 19 Mar. 2014, which claims priority to the German Application No. DE 10 2013 204 914.5 Med 20 Mar. 2013, the content of both incorporated herein by reference.

### BACKGROUND OF THE INVENTION

1. Field of the Invention

The invention relates to a sensor for detecting a gas content in an environment of the sensor.

2. Related Art

Sensors of this type can be used as oxygen sensors far the intake section of internal combustion engines such as gasoline or diesel engines. Oxygen sensors of this type are formed on the basis of YSZ ceramic, for example. These oxygen sensors comprise a sensor element, which is heated during operation to a temperature of up to 800° C. In an unfavorable case, if an ignitable gas-oxygen mixture reaches the sensor, this gas-oxygen mixture could be ignited by excessively high temperatures.

EP 2 3 63 707 A1 describes an NOx sensor comprising a sensor element and a heater, wherein an NOx concentration of a as is determined in a first inner hollow space of the sensor element. The hollow space is in flow connection with a gas inlet via a second diffusion limiter, a buffer space, and a first diffusion limiter.

The NOx sensor comprises, for example, a thermal insulating layer on an end face.

DE 10 2004 031 770 A1 describes a sensor unit for determining a physical parameter of a measuring gas, which sensor unit comprises a sensor housing and a protective device for protecting a sensor element. A gas inlet opening to a measuring space, in which the pump electrodes are disposed, is disposed coaxial with the longitudinal direction of the sensor element.

WO 03/073092 A1 describes a catalytically active layer, which is used as an electrode for a sensor element based on a solid electrolyte of a gas sensor in order to determine a gas component in a gas mixture. The catalytically active layer comprises a layer made of a first metal and at least one zone which is formed from at least one second metal for adjusting the catalytic activity of said layer.

WO 03/106989 A1 describes a sensor element for a sensor for determining the oxygen concentration in the exhaust gas of internal combustion engines, which sensor element comprises a solid electrolyte, which forms a pump cell with an internal electrode arranged in a hollow chamber and an external electrode which is exposed, on the outside, to the exhaust gas, an antechamber formed in the solid electrolyte, and a diffusion duct which is formed in the solid electrolyte, connects the antechamber and the hollow chamber to one another, and is filled with a diffusion barrier. In order to prevent measuring inaccuracies of the sensor in the case of extremely high quantities of hydrocarbons in the exhaust gas, a catalyst for oxidizing hydrocarbons is arranged in the antechamber, said catalyst being configured as an electrochemical catalyst comprising two electrically connected electrodes.

EP 2 058 652 A1 describes a gas sensor and a nitrogen oxide sensor, which, when adapted to the exhaust system of an internal combustion engine, can suppress the influence of pollutants contained in a gas to be measured and can prevent the reduction in sensitivity with the increase in use time.

### SUMMARY OF THE INVENTION

The problem addressed by the invention is that of producing a sensor which makes a contribution to ensuring that an air-fuel mixture flowing past is not ignited.

According to one aspect of the invention, a sensor for detecting a gas content in an environment of the sensor comprises a sensor body and an electrode chamber, which is formed in the sensor body. The sensor also comprises a first heating element, which is embedded in the sensor body and by which a specified region around the electrode chamber can be heated to a specified operating temperature. The sensor also has a longitudinal axis of the sensor body and an inlet duct in the sensor body, which is coupled to the electrode chamber and has an inlet on the surface of the sensor body, wherein the inlet is formed in the sensor body in such a way that, during operation of the sensor at the specified operating temperature, the inlet is axially spaced from the electrode chamber such that the sensor body is at a maximum temperature at the surface thereof in a specified region around the inlet, which temperature is less than or equal to a specified temperature threshold at which it is ensured that an air-fuel mixture flowing past the inlet will not be ignited, in that the inlet has an axial spacing from the electrode chamber corresponding to at least 40% of the overall axial length of the sensor body.

The specified operating temperature is a temperature between 600° C. and 850° C., for example. The specified region around the inlet is, for example, a region past which gas can flow. The temperature threshold value is specified such that, for example, an air-fuel mixture flowing past will not be ignited. This makes it possible to use the sensor in a region in which the sensor can come into contact with an air-fuel mixture. Since the inlet is located in a region at a maximum temperature which is below the temperature threshold value, an air-fuel mixture will not be ignited. The sensor is therefore ignition-proof.

According to one advantageous embodiment, the specified temperature threshold value is less than 300° C. 300° C. is an ignition temperature of an air-fuel mixture, for example.

According to another advantageous embodiment, the sensor comprises a thermal insulating sleeve on the sensor body, which extends at least axially in the direction of the longitudinal axis over the region of the electrode chamber and which insulates a specified part of the sensor body from an air-fuel mixture flowing past.

The sensor is therefore highly ignition-proof, since a surface of the sensor body that may be too hot cannot come into contact with an air-fuel mixture. The specified part is, for example, the part of the sensor body which can come into contact with an air-fuel mixture flowing past and/or is the part of the sensor body, the surface of which has a maximum temperature above the temperature threshold value.

According to another advantageous embodiment, the sensor comprises a second heating element, which is embedded in the sensor body and by which a specified region around the inlet duct can be heated to a specified temperature.

The specified temperature corresponds to a temperature, for example, at which pollutants can be burned out of the inlet duct in order to reopen the inlet duct. In this connection, it should be ensured that the second heating element is operated only when it is ensured that air-fuel mixture cannot reach the sensor at that moment.

According to another advantageous embodiment, the sensor comprises a lateral face that extends substantially parallel to the longitudinal axis, wherein the inlet is formed on the lateral face. A simple design of the sensor can be achieved in this manner.

### BRIEF DESCRIPTION OF THE DRAWINGS

Exemplary embodiments of the invention are explained in greater detail in the following with reference to the schematic drawings. In the drawings:

FIG. 1 shows a sensor for detecting a gas content;

FIG. 2 shows another exemplary embodiment of the sensor for detecting a gas content; and

FIG. 3 shows another view of the sensor for detecting the gas content.

### DETAILED DESCRIPTION OF THE PRESENTLY PREFERRED EMBODIMENTS

Elements having the same design or function are labeled with the same reference numbers in all the figures.

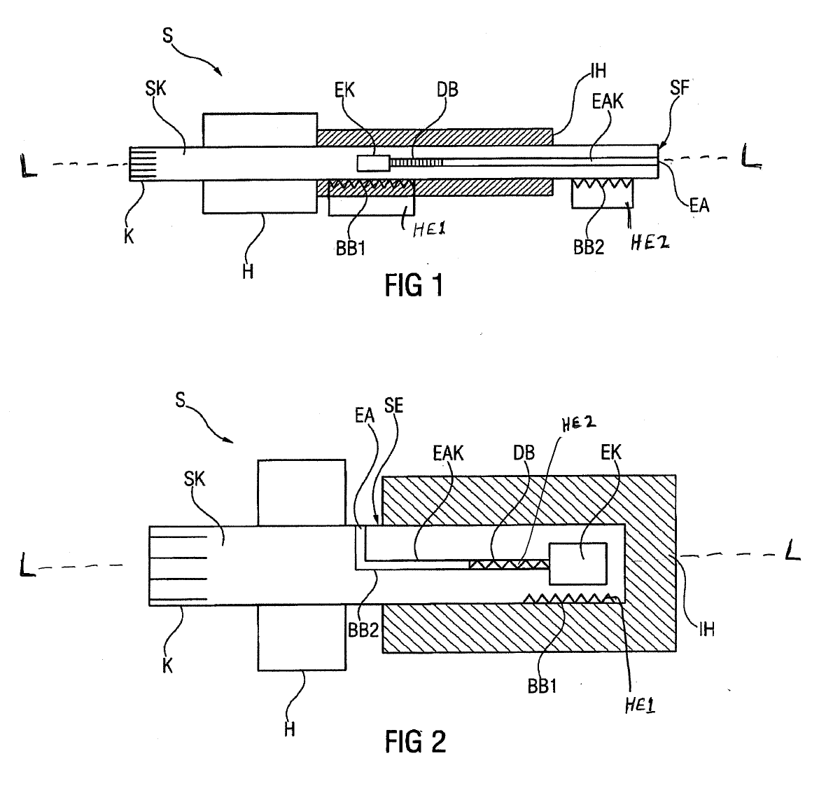

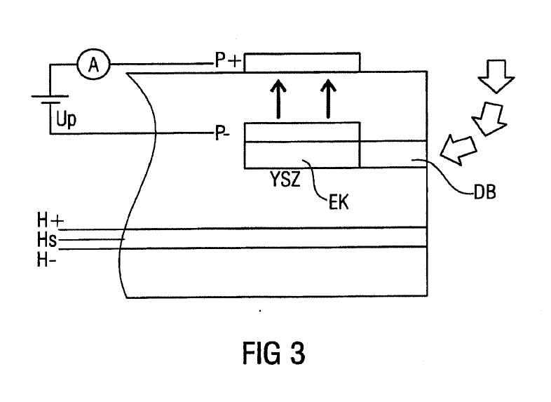

FIG. 1 shows a sensor S for detecting a gas content in an environment of the sensor S. The sensor S is configured as an oxygen sensor, in particular, that can detect an oxygen content in the environment of the sensor S. The sensor S has a sensor body SK. The sensor body SK has, for example, a substrate made of yttrium-stabilized zirconia YSZ (FIG. 3). An electrode chamber EK is formed in the sensor body SK. In addition, a first heating element is embedded in the sensor body SK, by which a specified region BB1 around the electrode chamber EK can be heated to a specified operating temperature. The specified operating temperature is between 600° C. and 850° C., for example, or is approximately 700° C.

Furthermore, the sensor S has a longitudinal axis L and an end face SF of the sensor body SK, which end face SF extends substantially perpendicular to the longitudinal axis L.

In addition, the sensor body SK comprises an inlet duct EAK, which is coupled to the electrode chamber EK and has an inlet EA in the surface of the sensor body SK, wherein the inlet EA in the embodiment in FIG. 1 is formed on the end face SF of the sensor body SK.

In the exemplary embodiment in FIG. 2, the inlet EA is formed on a lateral face SE of the sensor body SK, which lateral face SE extends substantially parallel to the longitudinal axis L. In each case, the inlet EA is formed in the sensor body SK in such a way that, during operation of the sensor S at the specified operating temperature, the inlet EA is axially spaced from the electrode chamber EK such that the sensor body SK is at a maximum temperature at the surface thereof in a specified region around the inlet EA, which temperature is less than or equal to a specified temperature threshold value at which it is ensured that an air-fuel mixture flowing past the inlet EA will not be ignited.

A diffusion barrier DB is formed between the inlet EA and the electrode chamber EK, through diffusion barrier DB which oxygen can diffuse into the electrode chamber EK.

The sensor S also comprises a thermal insulating sleeve IH, which is formed on the sensor body SK and extends at least axially in the direction of the longitudinal axis L over the region of the electrode chamber EK. The insulating sleeve IH can also cover the end face SF of the sensor body SK, for example, as shown in the embodiment in FIG. 2.

FIG. 3 shows another view of the sensor S. FIG. 3 illustrates the layered design of the sensor S. A first electrode P−, which can also be referred to as a cathode, is connected to the electrode chamber EK. A solid electrolyte layer is formed between the first electrode P− and a second electrode P+, which can also be referred to as an anode, which solid electrolyte layer is formed from yttrium-stabilized zirconia YSZ, for example.

The sensor S also comprises a plurality of contacts K (see FIGS. 1 and 2), for example for activating heating elements and for applying a voltage for operating the sensor S.

In addition, the sensor S comprises a holder H (see FIGS. 1 and 2), which can also be used to dissipate heat. To this end, the holder H is made from aluminum, for example, and is fastened on the sensor body SK by adhesive.

The mode of operation of the sensor S is described in the following.

In order to detect the gas content in the environment of the sensor S, a voltage difference of 0.8 V, for example, is applied between the first electrode P− and the second electrode P+. When the oxygen content under the cathode is set to 0 and the sensor S is introduced into an oxygenic environment, oxygen atoms diffuse through the diffusion barrier DB and the cathode into the substrate of the sensor body SK due to the difference in concentration and the difference in partial pressure between the environment and the region under the cathode, in which there is virtually no oxygen present. The oxygen atoms diffuse as doubly charged negative ions into the substrate of the sensor body SK, wherein the electrons required to ionize the oxygen atoms are supplied by the electrically conductive cathode. The differential diffusion limiting current is measured when a voltage is applied between the electrodes. In the case of an oxygenic measuring gas, this current is dependent on the oxygen partial pressure. At the anode, the oxygen ions are converted back to oxygen atoms and diffuse through the anode back into the oxygenic environment. The sensor body SK must be at an elevated temperature in order to ensure sufficient ionic conductivity. The sensor body SK is therefore heated to a specified operating temperature between 600° C. to 850° C., for example, in the heatable region BB1 of the electrode chamber EK by the first heating element HE1.

For the purpose of thermal insulation, the sensor S comprises the insulating sleeve IH, which insulates a specified part of the sensor body SK from an air-fuel mixture flowing past. The sensor S is therefore highly ignition-proof, since a surface of the sensor body SK that may be too hot cannot come into contact with an air-fuel mixture. The specified part is, for example, the part of the sensor body SK that can come into contact with an air-fuel mixture flowing past and/or that is the part of the sensor body SK, the surface of which is at a maximum temperature above the temperature threshold value.

The insulating sleeve IH comprises ceramic fibers and/or metal fibers, for example. The ceramic fibers and/or metal fibers are disposed in a metal sleeve, for example. As an alternative or in addition thereto, the ceramic fibers and/or metal fibers are spaced from the metal sleeve by an air gap.

In addition, the sensor S can comprise a second heating element HE2, which is embedded in the sensor body SK and by which a specified region BB2 around the inlet duct EAK can be heated to a specified temperature, which corresponds to a temperature, for example, at which pollutants can be burned out of the inlet duct EAK in order to reopen the inlet duct.

In this connection, it should be ensured that the second heating element HE2 is operated only when it is ensured that air-fuel mixture cannot reach the sensor S at that moment.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-5. (canceled)

6. A sensor (S) for detecting a gas content in an environment of the sensor (S), comprising:
a sensor body (SK) having a longitudinal axis (L);
an electrode chamber (EK) arranged in the sensor body (SK);
a first heating element (HE1), the first heating element (HE1) being embedded in the sensor body (SK) and being configured to heat a specified region (BB1) around the electrode chamber (EK) to a specified operating temperature; and
an inlet duct (EAK) in the sensor body (SK), the inlet duct (EAK) being coupled to the electrode chamber (EK) and having an inlet (EA) on the surface of the sensor body (SK),
wherein the inlet duct (EAK) is arranged in the sensor body (SK) such that, during operation of the sensor (S) at the specified operating temperature, the inlet (EA) is axially spaced from the electrode chamber (EK) such that the sensor body (SK) is at a maximum temperature at the surface of the sensor body in a region around the inlet (EA), which temperature is less than or equal to a temperature threshold that ensures that an air-fuel mixture flowing past the inlet (EA) will not be ignited, in that the inlet (EA) has axial spacing from the electrode chamber (EK) corresponding to at least 40% of the overall axial length of the sensor body (SK).

7. The sensor (S) as claimed in claim 6, wherein the temperature threshold value is less than 300° C.

8. The sensor (S) as claimed in claim 6, further comprising a thermal insulating sleeve (IH) on the sensor body (SK), the thermal insulating sleeve (IH) extending at least axially in the direction of the longitudinal axis (L) over the region of the electrode chamber (EK) and insulating a part of the sensor body (SK) with respect to an air-fuel mixture flowing past.

9. The sensor (S) as claimed in claim 6, further comprising a second heating element (HE2), the second heating element (HE2) being embedded in the sensor body (SK) and being configured to heat a second specified region (BB2) around the inlet duct (EAK) to a specified temperature.

10. The sensor (S) as claimed in claim 6, further comprising a lateral surface (SF) extending substantially parallel to the longitudinal axis (L), wherein the inlet (EA) is arranged in the lateral surface (SF).
